(19) United States
(12) Patent Application Publication
(10) Pub. No.: US 2006/0160954 A1
(43) Pub. Date: Jul. 20, 2006

(54) Preparation of graft copolymers by sequential polymerization using peroxide-containing polyolefins

(75) Inventors: Vu A. Dang, Bear, DE (US); Cheng Q. Song, Green Brook, NJ (US)

Correspondence Address: BASELL USA INC., INTELLECTUAL PROPERTY, 912 APPLETON ROAD, ELKTON, MD, 21921, US

(73) Assignee: Basell Poliolefine Italia s.r.l., Milan (IT)

(21) Appl. No.: 11/302,395

(22) Filed: Dec. 13, 2005

Related U.S. Application Data
(60) Provisional application No. 60/636,263, filed on Dec. 14, 2004.

(51) Int. Cl. C08F 297/02

(52) U.S. Cl. 525/242

(57) ABSTRACT

A process for making a graft copolymer of an olefin polymer material in at least two polymerization stages comprising: a) treating a reactive, peroxide-containing olefin polymer material (A) at a temperature from about 80° C. to a temperature below the softening point of the polymer material with about 5 to about 120 parts per hundred parts of the polymer material (A) by weight (pph) of at least one grafting monomer which is polymerizable by free radicals; b) treating the stage a) graft copolymer at a temperature from about 80° C. to a temperature below the softening point of the stage a) graft copolymer, which is the same as or different from the temperature used in stage a), with about 5 to about 120 pph of at least one grafting monomer which is different from the monomer used in stage a) and polymerizable by free radicals.

### FIELD OF THE INVENTION

This invention relates to a process for preparing sequentially grafted olefin polymer materials by reacting peroxide-containing olefin polymers with vinyl monomers.

### BACKGROUND OF THE INVENTION

Graft polyolefins have been of interest for some time because they are capable of possessing some properties of the grafted polymer in which monomer or monomers were polymerized to form graft chains as well as of the olefin polymer backbone. It has been suggested, for example, that certain of these graft copolymers be used as compatibilizers for normally immiscible polymer systems if the graft chain and the olefin polymer backbone are compatible with each phase of the immiscible polymer blend, respectively.

It is known that graft copolymers can be prepared by creating active sites on the backbone of the main polymer. The graft polymerization of a polymerizable monomer or monomers is then initiated by these sites. Procedures which have been used for introducing such active sites into the polymer backbone have included treatment with organic chemical compounds capable of generating free radicals, and irradiation. In the chemical method, an organic chemical compound capable of generating free radicals, such as a peroxide or azo compound, is decomposed in the presence of the backbone polymer with the formation of free radicals, which form the active grafting sites on the polymer and initiate the polymerization of the monomer at these sites. In the irradiation method, the backbone polymer is treated with high energy ionizing radiation, such as electron beam irradiation. The free radicals generated on the backbone of the irradiated polymer form the active grafting sites which is capable of initiating free radical polymerization to produce graft copolymers.

Of the various techniques which have been employed for preparing graft copolymers, the bulk technique, in which the polymer particles are contacted directly with the initiator and monomer, without the intervention of a liquid suspending medium or a solvent, is advantageous in terms of simplicity of execution and the avoidance of side-reactions caused by the presence of certain solvents or suspending media, such as water. However, regardless of the physical state of the polymer to be grafted, the grafting process is subject to problems such as degradation of the polyolefin, possibly leading to a graft copolymer having an undesirably high melt flow rate, and excessive formation of the homopolymer of the grafting monomer at the expense of the formation of the grafted chains when an organic peroxide is used as an initiator.

U.S. Pat. No. 4,595,726 discloses graft copolymers of 3-100%, preferably 3-30%, by weight of an alkyl methacrylate moiety grafted onto a polypropylene backbone. The graft copolymers, useful as adhesives in polypropylene laminates, are prepared at a temperature below the softening point of polypropylene by a solvent-free reaction, reportedly vapor-phase, between polypropylene and the methacrylate monomer in the presence of a free radical forming catalyst. A preferred initiator is tert-butyl perbenzoate, stated as having a 15-minute half-life at 135° C., and reactor temperatures of 135° C. and 140° C. are disclosed. Degradation of the polypropylene chain due to the reaction conditions employed is reported. Immediately after the peroxide is added to the polypropylene, the monomer is added over a time period which is fixed by the half-life of the peroxide initiator (i.e., 1-2 half-lives). In other words, according to the teachings of U.S. Pat. No. 4,595,726, for a given initiator half-life, it is necessary to employ a higher rate of addition of the monomer as the total amount of monomer to be added increases.

The preparation of “graft-type” copolymers by dissolving an organic peroxide in a monomer and adding the solution to free-flowing particles of the base polymer, particularly polyvinyl chloride, is described in U.S. Pat. No. 3,240,843. The “graft-type” products are described as having monomeric, as opposed to polymeric, branches attached to the polymer backbone. Homopolymerization of the monomer also is mentioned. To avoid particle agglomeration, the amount of monomer added cannot exceed the maximum absorbable by the polymer particles. In the case of polypropylene charged into a reactor with a solution containing styrene, butadiene, acrylonitrile, and benzoyl peroxide, the total amount of monomers added is only 9% of the amount of polypropylene charged.

U.S. Pat. No. 5,140,074 discloses a method of producing olefin polymer graft copolymers by contacting a particulate olefin polymer with a free radical polymerization initiator such as peroxide. According to this process the olefin polymer is grafted with at least one monomer in only one stage. When two or more monomers are grafted they are copolymerized onto the polymer backbone forming a random graft copolymer instead of two individual polymer grafts.

As recognized in U.S. Pat. No. 5,037,890, all of the above grafting techniques using an organic peroxide as a grafting initiator involves many problems, such as susceptibility to gellation and readiness in homopolymerization of the graft monomer, therefore, lowering in grafting efficiency since most free radicals formed by decomposition of the organic peroxide are not attached to the backbone of the olefin polymer materials.

The grafted polymer can also be prepared by using irradiation to initiate the grafting polymerization. For example, U.S. Pat. No. 5,411,994 discloses a method for making polyolefin graft copolymers by irradiating olefin polymer particles and treating with a vinyl monomer in liquid form under a non-oxidizing environment which is maintained throughout the process. U.S. Pat. No. 5,817,707 discloses a process for making a graft copolymer by irradiating a porous propylene polymer material in the absence of oxygen, adding a controlled amount of oxygen to produce an oxidized propylene polymer material and then heating, dispersing the oxidized polymer in water in the presence of a surfactant to react with a vinyl monomer by using a redox initiator system.

Graft polymers with low molecular weight side chains are prepared by using a polymeric peroxide as an initiator as disclosed in U.S. Pat. No. 6,444,722. A propylene polymer material is irradiated, oxidized and then treated with vinyl monomers in order to prepare the graft polymers. An important advantage of the grafting process using a polymeric peroxide initiator, which is a reactive, peroxide-containing olefin polymer, is that the graft copolymer has a higher grafting efficiency as compared with that prepared by using an organic peroxide. For example, the grafting efficiency reported in U.S. Pat. No. 6,444,722 (table 3) for a styrene graft copolymer using a polymeric peroxide is 39.4% whereas the grafting efficiency reported in U.S. Pat. No. 5,916,974 for a styrene graft copolymer prepared with an organic peroxide is only 25.7% (table 11).

Sequentially grafting an olefin polymer material is also known by treating the olefin polymer material with an organic peroxide and then adding vinyl monomers to the olefin polymer material in two separate polymerization stages. U.S. Pat. No. 5,539,057 discloses a process in which an olefin polymer is treated with an organic peroxide and a grafting monomer in a first stage of polymerization. After the first stage of polymerization, the un-reacted monomer is removed and un-reacted initiator is deactivated. The second stage of polymerizatoin starts by treating the olefin polymer with a second dose of an organic peroxide and a second grafting monomer. The peroxide used in the sequentially grafting polymerization does not only require a deactivation step between the first stage and the second stage but also generates a certain amount of homopolymerization of the grafting monomers since the free radical formed by decomposing the peroxide is not initially on the backbone of the olefin polymer material.

In addition, since organic peroxides are unstable and explosive chemicals, they require special safe handling procedures to minimize the risk. It is also well known that the degradation products from the organic peroxide, such as t-butyl alcohol, undesirably remain in the final product and render the product unsuitable for certain applications.

Accordingly, it is an object of this invention to produce a sequentially grafted copolymer without using an organic peroxide in order to achieve desirable characteristics, eliminate the above-mentioned difficulties associated with the handling of organic peroxides and to avoid the toxic by-products resulting from their use.

### SUMMARY OF THE INVENTION

In accordance with the present invention, a sequentially grafting polymerization process for making graft copolymers by using a reactive, peroxide-containing olefin polymer as an initiator is disclosed.

The present invention relates to a process for making a graft copolymer of an olefin polymer material in at least two polymerization stages comprising:
a) treating a reactive, peroxide-containing olefin polymer material (A) at a first temperature from about 80° C. to a temperature below the softening point of the polymer material with about 5 to about 120 parts per hundred parts of the polymer material (A) by weight (pph) of at least one grafting monomer which is polymerizable by free radicals, thereby forming a stage a) graft copolymer;
b) treating the stage a) graft copolymer, after at least about 50%, preferably about 80%, most preferably about 90% by weight of the monomer used in stage a) has been converted to polymer, at a second temperature from about 80° C. to a temperature below the softening point of the stage a) graft copolymer, which is the same as or different from the temperature used in stage a), with about 5 to about 120 pph of at least one grafting monomer which is different from the monomer used in stage a) and polymerizable by free radicals; and
c) simultaneously or successively in optional order,
   (i) deactivating substantially all residual free radicals in the resultant graft copolymer at a temperature not lower than the second temperature; and
   (ii) removing any unreacted vinyl monomer from the graft copolymer.

The grafting monomer can be contacted with the reactive, peroxide-containing olefin polymer material continuously or intermittently. The process of the invention can be carried out in a semi-batch, semi-continuous, or continuous process.

The present invention also relates to a graft copolymer made by the process described above. The graft copolymer has a grafting efficiency not less than 30%, preferably more than 35%, most preferably more than 40%, wherein the grafting efficiency is 100×(C₀−C)/C₀, where C and C₀ are concentrations of the soluble polymerized monomer fraction in xylene at room temperature and the total polymerized monomer formed in the grafting process, respectively.

### BRIEF DESCRIPTION OF THE DRAWINGS

FIG. 1 is NMR Spectra of a Random Copolymer made in Comparative Example 1 and a Block Copolymer made in Example 1.

### DETAILED DESCRIPTION OF THE INVENTION

Olefin polymer suitable as a starting material for preparation of the reactive, peroxide-containing olefin polymer material (A) is a propylene polymer material, an ethylene polymer material, a butene-1 polymer material, or mixtures thereof. The olefin polymer used in the present invention can be selected from:
(a) a crystalline homopolymer of propylene having an isotactic index greater than about 80%, preferably about 90% to about 99.5%;
(b) a crystalline, random copolymer of propylene with an olefin selected from ethylene and C₄-C₁₀ α-olefins wherein the polymerized olefin content is about 1-10% by weight, preferably about 2% to about 8%, when ethylene is used, and about 1% to about 20% by weight, preferably about 2% to about 16%, when the C₄-C₁₀ α-olefin is used, the copolymer having an isotactic index greater than about 60%, preferably at least about 70%;
(c) a crystalline, random terpolymer of propylene and two olefins selected from ethylene and C₄-C₈ α-olefins wherein the polymerized olefin content is about 1% to about 5% by weight, preferably about 1% to about 4%, when ethylene is used, and about 1% to about 20% by weight, preferably about 1% to about 16%, when the C₄-C₁₀ α-olefins are used, the terpolymer having an isotactic index greater than about 85%; and
(d) an olefin polymer composition comprising:
   (i) about 10% to about 60% by weight, preferably about 15% to about 55%, of a crystalline propylene homopolymer having an isotactic index at least about 80%, preferably about 90 to about 99.5%, or a crystalline copolymer of monomers selected from (a) propylene and ethylene, (b) propylene, ethylene and a C₄-C₈ α-olefin, and (c) propylene and a C₄-C₈ α-olefin, the copolymer having a polymerized propylene content of more than about 85% by weight, preferably about 90% to about 99%, and an isotactic index greater than about 60%;
   (ii) about 3% to about 25% by weight, preferably about 5% to about 20%, of a copolymer of ethylene and propylene or a C₄-C₈ α-olefin that is insoluble in xylene at ambient temperature; and
   (iii) about 10% to about 80% by weight, preferably about 15% to about 65%, of an elastomeric copolymer of monomers selected from (a) ethylene and propylene, (b) ethylene, propylene, and a C₄-C₈ α-olefin, and (c) ethylene and a C₄-C₈ α-olefin, the copolymer optionally containing about 0.5% to about 10% by weight of a polymerized diene and containing less than about 70% by weight, preferably about 10% to about 60%, most preferably about 12% to about 55%, of polymerized ethylene, and being soluble in xylene at ambient temperature and having an intrinsic viscosity of about 1.5 to about 6.0 dl/g;
wherein the total of (ii) and (iii), based on the total olefin polymer composition is about 50% to about 90% by weight, and the weight ratio of (ii)/(iii) is less than about 0.4, preferably 0.1 to 0.3, and the composition is prepared by polymerization in at least two stages;
(e) homopolymers of ethylene;
(f) random copolymers of ethylene and an α-olefin selected from C₃-C₁₀ α-olefins having a polymerized α-olefin content of about 1 to about 20% by weight, preferably about 2% to about 16%;
(g) random terpolymers of ethylene and two C₃-C₁₀ α-olefins having a polymerized α-olefin content of about 1% to about 20% by weight, preferably about 2% to about 16%;
(h) homopolymers of butene-1;
(i) copolymers or terpolymers of butene-1 with ethylene, propylene or C₅-C₁₀ α-olefin, the comonomer content ranging from about 1 mole % to about 15 mole %; and
(j) mixtures thereof.

Preferably, the olefin polymer is selected from:
(a) a crystalline homopolymer of propylene having an isotactic index greater than about 80%, preferably about 90% to about 99.5%; and
(b) a crystalline, random copolymer of propylene with an olefin selected from ethylene and C₄-C₁₀ α-olefins wherein the polymerized olefin content is about 1-10% by weight, preferably about 2% to about 8%, when ethylene is used, and about 1% to about 20% by weight, preferably about 2% to about 16%, when the C₄-C₁₀ α-olefin is used, the copolymer having an isotactic index greater than about 60%, preferably at least about 70%;

Most preferably, the olefin polymer is a propylene homopolymer having an isotactic index greater than about 90%.

The useful polybutene-1 homo or copolymers can be isotactic or syndiotactic and have a melt flow rate (MFR) from about 0.1 to 150 dg/min, preferably from about 0.3 to 100, and most preferably from about 0.5 to 75.

These butene-1 polymer materials, their methods of preparation and their properties are known in the art. Suitable polybutene-1 polymers can be obtained, for example, by using Ziegler-Natta catalysts to initiate butene-1 polymerization, as described in WO 99/45043, or by metallocene initiated polymerization of butene-1 as described in WO 02/102811, the disclosures of which are incorporated herein by reference.

Preferably, the butene-1 polymer materials contain up to about 15 mole % of copolymerized ethylene or propylene. More preferably, the butene-1 polymer material is a homopolymer having a crystallinity of at least about 30% by weight measured with wide-angle X-ray diffraction after 7 days, more preferably about 45% to about 70%, most preferably about 55% to about 60%.

Suitable forms of the olefin polymer material used in the present process include powder, flake, granulate, spherical, cubic and the like. Spherical particulate forms are preferred. The pore volume fraction can be as low as about 0.04, but it is preferred that the grafting be effected on olefin polymer particles having a pore volume fraction of at least 0.07. Most preferably, the olefin polymer used in this invention will have a pore volume of at least about 0.12, and most preferably at least about 0.20, with more than 40%, preferably more than 50%, and most preferably more than 90%, of the pores having a diameter larger than 1 micron, a surface area of at least 0.1 m²/g, and a weight average diameter of about from 0.4 to 7 mm. In the preferred polymer, grafting takes place in the interior of the particulate material as well as on the external surface thereof, resulting in a substantially uniform distribution of the graft polymer throughout the olefin polymer particle.

The pore volume fraction values were determined by a mercury porosimetry technique in which the volume of mercury absorbed by the particles is measured. The volume of mercury absorbed corresponds to the volume of the pores. This method is described in Winslow, N. M. and Shapiro, J. J., “An Instrument for the Measurement of Pore-Size Distribution by Mercury Penetration,” ASTM Bull., TP 49, 3944 (February 1959), and Rootare, H. M., “A Review of Mercury Porosimetry,” 225-252 (In Hirshhom, J. S. and Roll, K. H., Eds., Advanced Experimental Techniques in Powder Metallurgy, Plenum Press, New York, 1970).

The surface area measurements were made by the B.E.T. method as described in JACS 60, 309 (1938).

The reactive, peroxide-containing olefin polymer has a peroxide concentration typically ranging from about 5 to about 200 milli-equivalent per kilogram of the polymer (meq/kg), and preferably ranging from about 10 to about 50.

The reactive, peroxide-containing olefin polymer may be prepared by using an irradiation and oxidation process by exposing the olefin polymer starting material to high energy ionizing radiation in an essentially oxygen-free environment, i.e., an environment in which the active oxygen concentration is established and maintained at 0.004% by volume or less. The olefin polymer starting material is exposed to high-energy ionizing radiation under a blanket of inert gas, preferably nitrogen. The ionizing radiation should have sufficient energy to penetrate the mass of polymer material being irradiated to the extent desired. The ionizing radiation can be of any kind, but preferably includes electrons and gamma rays. More preferred are electrons beamed from an electron generator having an accelerating potential of 500-4,000 kilovolts. Satisfactory results are obtained at a dose of ionizing radiation of about 0.1 to about 15 megarads (“Mrad”), preferably about 0.5 to about 9.0 Mrad.

The term “rad” is usually defined as that quantity of ionizing radiation that results in the absorption of 100 ergs of energy per gram of irradiated material regardless of the source of the radiation using the process described in U.S. Pat. No. 5,047,446. Energy absorption from ionizing radiation is measured by the well-known convention dosimeter, a measuring device in which a strip of polymer film containing a radiation-sensitive dye is the energy absorption sensing means. Therefore, as used in this specification, the term “rad” means that quantity of ionizing radiation resulting in the absorption of the equivalent of 100 ergs of energy per gram of the polymer film of a dosimeter placed at the surface of the olefin material being irradiated, whether in the form of a bed or layer of particles, or a film, or a sheet.

The irradiated olefin polymer material is then oxidized in a series of steps. According to a preferred preparation method, the first treatment step consists of heating the irradiated polymer in the presence of a first controlled amount of active oxygen greater than 0.004% by volume but less than 21% by volume, preferably less than 15% by volume, more preferably less than 8% by volume, and most preferably from 0.5% to 5.0% by volume, to a first temperature of at least 25° C. but below the softening point of the polymer, preferably about 25° C. to 140° C., more preferably about 40° C. to 100° C., and most preferably about 50° C. to 90° C. Heating to the desired temperature is accomplished as quickly as possible, preferably in less than 10 minutes. The polymer is then held at the selected temperature, typically for about 5 to 90 minutes, to increase the extent of reaction of the oxygen with the free radicals in the polymer. The holding time, which can be determined by one skilled in the art, depends upon the properties of the starting material, the active oxygen concentration used, the irradiation dose, and the temperature. The maximum time is determined by the physical constraints of the fluid bed used to treat the polymer.

In the second treatment step, the irradiated polymer is heated in the presence of a second controlled amount of oxygen greater than 0.004% by volume but less than 21% by volume, preferably less than 15% by volume, more preferably less than 8% by volume, and most preferably from 0.5% to 5.0% by volume to a second temperature of at least 25° C. but below the softening point of the polymer. Preferably, the second temperature is from 80° C. to less than the softening point of the polymer, and the same as or greater than the temperature of the first treatment step. The polymer is then held at the selected temperature and oxygen concentration conditions for about 10 to 300 minutes, preferably about 20 to 180 minutes, most preferably about 30 to 60 minutes, to minimize the recombination of chain fragments, i.e., to minimize the formation of long chain branches. The holding time is determined by the same factors discussed in relation to the first treatment step.

In the optional third step, the oxidized olefin polymer material is heated under a blanket of inert gas, preferably nitrogen, to a third temperature of at least 80° C. but below the softening point of the polymer, and held at that temperature for about 10 to about 120 minutes, preferably about 60 minutes. A more stable product is produced if this step is carried out. It is preferred to use this step if the reactive, peroxide-containing olefin polymer material is going to be stored rather than used immediately, or if the radiation dose that is used is on the high end of the range described above. The polymer is then cooled to a fourth temperature of about below 50° C. under a blanket of inert gas, preferably nitrogen, before being discharged from the bed. In this manner, stable intermediates are formed that can be stored at room temperature for long periods of time without further degradation.

As used in this specification, the expression “room temperature” or “ambient” temperature means approximately 25° C. The expression “active oxygen” means oxygen in a form that will react with the irradiated olefin polymer material. It includes molecular oxygen, which is the form of oxygen normally found in air. The active oxygen content requirement of this invention can be achieved by replacing part or all of the air in the environment by an inert gas such as, for example, nitrogen.

It is preferred to carry out the treatment by passing the irradiated polymer through a fluid bed assembly operating at a first temperature in the presence of a first controlled amount oxygen, passing the polymer through a second fluid bed assembly operating at a second temperature in the presence of a second controlled amount of oxygen, and then maintaining the polymer at a third temperature under a blanket of nitrogen, in a third fluid bed assembly. In commercial operation, a continuous process using separate fluid beds for the first two steps, and a purged, mixed bed for the third step is preferred. However, the process can also be carried out in a batch mode in one fluid bed, using a fluidizing gas stream heated to the desired temperature for each treatment step. Unlike some techniques, such as melt extrusion methods, the fluidized bed method does not require the conversion of the irradiated polymer into the molten state and subsequent re-solidification and comminution into the desired form. The fluidizing medium can be, for example, nitrogen or any other gas that is inert with respect to the free radicals present, e.g., argon, krypton, and helium.

The concentration of peroxide groups formed on the polymer can be controlled easily by varying the radiation dose during the preparation of the reactive, peroxide-containing olefin polymer and the amount of oxygen to which such polymer is exposed after irradiation. The oxygen level in the fluid bed gas stream is controlled by the addition of dried, filtered air at the inlet to the fluid bed. Air must be constantly added to compensate for the oxygen consumed by the formation of peroxides in the polymer.

Alternatively, the reactive, peroxide-containing olefin polymer materials could be prepared according to the following procedures. In the first treatment step, the polymer starting material was treated with 0.1 to 10 wt % of an organic peroxide initiator while adding a controlled amount of oxygen so that the olefin polymer material is exposed to greater than 0.004% but less than 21% by volume, preferably less than 15%, more preferably less than 8% by volume, and most preferably 1.0% to 5.0% by volume, at a temperature of at least 25° C. but below the softening point of the polymer, preferably about 25° C. to about 140° C. In the second treatment step, the polymer is then heated to a temperature of at least 25° C. up to the softening point of the polymer, preferably from 100° C. to less than the softening point of the polymer, at an oxygen concentration that is within the same range as in the first treatment step. The total reaction time is typically about 0.5 hour to four hours. After the oxygen treatment, the polymer is treated at a temperature of at least 80° C. but below the softening point of the polymer, typically for 0.5 hour to about two hours, in an inert atmosphere such as nitrogen to quench any active free radicals.

Suitable organic peroxides include acyl peroxides, such as benzoyl and dibenzoyl peroxides; dialkyl and aralkyl peroxides, such as di-tert-butyl peroxide, dicumyl peroxide; cumyl butyl peroxide; 1,1,-di-tert-butylperoxy-3,5,5-trimethylcyclohexane; 2,5-dimethyl-1,2,5-tri-tert-butylperoxyhexane, and bis(alpha-tert-butylperoxy isopropylbenzene), and peroxy esters such as bis(alpha-tert-butylperoxy pivalate; tert-butylperbenzoate; 2,5-dimethylhexyl-2,5-di(perbenzoate); tert-butyl-di(perphthalate); tert-butylperoxy-2-ethylhexanoate, and 1,1-dimethyl-3-hydroxybutylperoxy-2-ethyl hexanoate, and peroxycarbonates such as di(2-ethylhexyl)peroxy dicarbonate, di(n-propyl)peroxy dicarbonate, and di(4-tert-butylcyclohexyl)peroxy dicarbonate. The peroxides can be used neat or in diluent medium.

The reactive, peroxide-containing olefin polymers used in the process of the invention are easy to handle and may be stored for long periods of time without the need of specific storage requirement. The resultant graft copolymer has low degradation by-product and high grafting efficiency.

The grafting monomer includes any monomeric vinyl compound that is capable of being polymerized or grafted by free radicals, wherein the monomer has one or more unsaturated bonds and the monomer can contain a straight or branched aliphatic chain or a substituted or unsubstituted aromatic, heterocyclic, or alicyclic ring in a mono- or polycyclic compound. Typical substituent groups can be alkyl, hydroxyalkyl, aryl, and halo. Usually the vinyl monomer will be a member of one of the following classes:
(a) vinyl-substituted aromatic, heterocyclic, or alicyclic compounds;
(b) unsaturated aliphatic nitriles, carboxylic acids and their esters;
(c) unsaturated acid anhydrides and salts; and
(d) halogenated vinyl compounds.

Examples of the grafting monomer include styrene, vinylnaphthalene, vinylpyridine, vinylpyrrolidone, vinylcarbazole, methylstyrenes, methylchlorostyrene, p-tert-bulylstyrene, methylvinylpyridine, ethylvinylpyridine, acrylonitrile, methacrylonitrile, acrylic acid esters, such as butyl acrylate, methacrylic acid esters, such as methyl methacrylate, unsaturated acid anhydrides, salts of unsaturated acid, acrylic acids, methacrylic acid, and mixtures thereof.

The grafting monomer, if liquid at room temperature can be used neat or in combination with a solvent or diluent which is inert with respect to the olefin polymer material. If a solid at room temperature, the grafting monomer can be used in solution with a solvent which is inert as set forth above. Mixtures of a neat monomer, a diluent monomer, and/or a dissolved monomer can be used. In all cases, whether or not a solvent or diluent is present, the amount of grafting monomer given is based on the actual monomer content.

When a diluent for the monomer is used, less than about 70%, preferably less than 50%, and most preferably less than 25% by weight, based on the weight of the monomer of the diluent is used to reduce the cost of recovery of the diluent after polymerization. But the graft level is normally not affected significantly by the use of diluent. Use of solvent in excess of the amount required to dissolve the monomer should be avoided for the same reason.

Solvents or diluents used are those compounds which are inert as described above and which have a chain transfer constant of less than about 10⁻³. Suitable solvents or diluents include ketones, such as acetone, alcohols, such as methanol; aromatic hydrocarbons such as benzene and xylene; and cycloaliphatic hydrocarbons, such as cyclohexane.

The amount of grafting monomer or monomers used in stage a) or stage b) of the graft copolymerization is about 1 to about 150 parts per hundred parts of the reactive, peroxide-containing olefin polymer material by weight (pph), preferably about 5 to about 120 pph, most preferably about 10 to about 50 pph.

Unless otherwise specified, the properties of the olefin polymer materials, compositions and other characteristics that are set forth in the following examples have been determined according to the test methods reported below:
Melt Flow Rate (“MFR”): ASTM D1238, units of dg/min; 230° C.; 2.16 kg; Polymer material with a MFR below 100, using full die; Polymer material with a MFR equal or above 100, using ½ die; unless otherwise specified.
Isotactic Index (“I.I.”): Defined as the percent of olefin polymer insoluble in xylene. The weight percent of olefin polymer soluble in xylene at room temperature is determined by dissolving 2.5 g of polymer in 250 ml of xylene at room temperature in a vessel equipped with a stirrer, and heating at 135° C. with agitation for 20 minutes. The solution is cooled to 25° C. while continuing the agitation, and then left to stand without agitation for 30 minutes so that the solids can settle. The solids are filtered with filter paper, the remaining solution is evaporated by treating it with a nitrogen stream, and the solid residue is vacuum dried at 80° C. until a constant weight is reached. These values correspond substantially to the isotactic index determined by extracting with boiling n-heptane, which by definition constitutes the isotactic index of polypropylene.
Peroxide Concentration: Quantitative Organic Analysis via Functional Groups, by S. Siggia et al., 4th Ed., NY, Wiley 1979, pp. 334-42.
Flexural Modulus ASTM D790-92 (@1% secant)
Notched Izod ASTM D-256-87
Elongation @ Break ASTM D-638
Tensile Strength ASTM D-638
Heat Deflection Temperature
(HDT): ASTM D648-01B

In this specification, all parts, percentages and ratios are by weight, and all properties are measured at room temperature unless otherwise specified.

The reactive, peroxide-containing olefin polymer materials used in the experiments are prepared according to the following procedures.

Preparation 1

A reactive, peroxide-containing propylene polymer was prepared from a propylene homopolymer having a melt flow rate (MFR) of 10.0 dg/min, and I.I. of 96.5%, commercially available from Basell USA Inc. The polymer was irradiated at 0.5 Mrad under a blanket of nitrogen. The irradiated polymer was then treated with 0.8% by volume of oxygen at 140° C. for 60 minutes. The oxygen was then removed and the polymer was heated at 140° C. under a blanket of nitrogen for 60 minutes, then cooled and collected. The MFR of the reactive, peroxide containing propylene polymer was 131 dg/min. The peroxide concentration was 9.6 meq/kg of polymer.

Preparation 2

A reactive, peroxide-containing propylene polymer was prepared from a propylene homopolymer having a MFR of 10.0 dg/min, and I.I. of 96.5%, commercially available from Basell USA Inc. The polymer was irradiated at 0.5 Mrad under a blanket of nitrogen. The irradiated polymer was then treated with 1.1% by volume of oxygen at 140° C. for 60 minutes. The oxygen was then removed and the polymer was heated at 140° C. under a blanket of nitrogen for 60 minutes, then cooled and collected. The MFR of the reactive, peroxide-containing propylene polymer was 309 dg/min. The peroxide concentration was 12.0 meq/kg of polymer.

### EXAMPLE 1

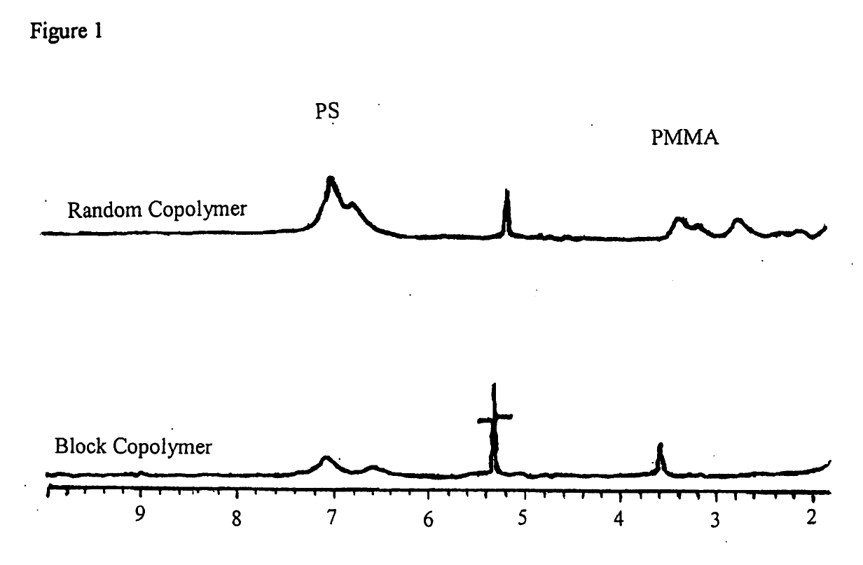

The reactive, peroxide-containing propylene polymer made in Preparation 1 was added to a 3 liter jacketed glass reactor equipped with an agitator. The reactor was heated to and held at 135° C. for 15 min. Then, 20 pph methyl methacrylate (MMA), with respect to the amount of the peroxide-containing propylene polymer, was added to the reactor at a rate of 17 ml/min. Upon the completion of MMA addition, 20 pph styrene, with respect to the amount of the peroxide-containing propylene polymer, was added to the reactor at a rate of 17 ml/min. The reactor temperature was then maintained at 135° C. for another 60 minutes. The reactor vent was then opened and a stream of nitrogen was introduced. The reactor was held at 135° C. for another hour to remove any un-reacted monomer and deactivate any residual free radicals and un-decomposed peroxides. The resultant graft copolymer was cooled and collected. The MFR of the resultant graft copolymer is 40 dg/min. Nuclear Magnetic Resonance (NMR) analysis of the polymer is attached as FIG. 1. The spectrum of the polymer, labeled as Block Copolymer, was obtained by analyzing a solution of the polymer in CD₂Cl₂ using a proton NMR, Bruker Advance 500. The spectrum showed a singlet peak of methyl groups of the polymethyl methacrylate grafts at a chemical shift around 3.6 ppm.

The singlet peak of the Example 1 shows the characteristics of the polymerized methyl methacrylate blocks in the polymer made by the sequentially grafting technique.

### COMPARATIVE EXAMPLE 1

The reactive, peroxide-containing propylene polymer made in Preparation 1 was added to a 3 liter jacketed glass reactor equipped with an agitator. The reactor was heated to and held at 135° C. for 15 min. Then a mixture of 20 pph methyl methacrylate (MMA) and 20 pph styrene, with respect to the amount of the peroxide-containing propylene polymer, was added to the reactor at a rate of 17 ml/min. Upon the completion of monomer addition, the reactor temperature was maintained at 135° C. for another 60 minutes. The reactor vent was then opened and a stream of nitrogen was introduced. The reactor was held at 135° C. for another hour to remove any un-reacted monomer and deactivate any residual free radicals and un-decomposed peroxides. The resultant graft copolymer was cooled and collected. The MFR of the resultant graft copolymer is 75 dg/min. Nuclear Magnetic Resonance (NMR) analysis of the polymer is attached as FIG. 1. The spectrum of the polymer, labeled as Random Copolymer, was obtained by analyzing a solution of the polymer in CD₂Cl₂ using a proton NMR, Bruker Advance 500. The spectrum showed a multiplet peak of methyl groups at a chemical shift around 2.8-3.6 ppm.

The multiplet peak of the Comparative Example 1 shows the randomness of the copolymerization of the MMA and styrene monomers made in a single grafting polymerization.

### EXAMPLE 2 (EX. 2)

The reactive, peroxide-containing propylene polymer made in Preparation 2 was added to a 3 liter jacketed glass reactor equipped with an agitator. The reactor was heated to and held at 135° C. for 15 min. Then, 10 pph butyl acrylate (BA), with respect to the amount of the peroxide-containing propylene polymer, was added to the reactor at a rate of 5 ml/min. Upon the completion of BA addition, 10 pph styrene, with respect to the amount of the peroxide-containing propylene polymer, was added to the reactor at a rate of 5 ml/min. The reactor temperature was then maintained at 135° C. for another 60 minutes. The reactor vent was then opened and a stream of nitrogen was introduced. The reactor was held at 135° C. for another hour to remove any un-reacted monomer and deactivate any residual free radicals and un-decomposed peroxides. The resultant graft copolymer was cooled and collected. The MFR of the resultant graft copolymer is 61 dg/min.

The graft copolymer was compounded by firstly dry-blending and bag mixing with 0.2% by weight of Irganox B225 antioxidant and 0.1% by weight of calcium stearate. Irganox B225 antioxidant is a 1:1 blend of Irganox 1010 antioxidant and Irgafos 168 tris(2,4-di-t-butylphenyl)phosphite antioxidant. Both Irganox B225 and calcium stearate are commercially available from Ciba Specialty Chemicals Corporation. The obtained polymer mixture was then extruded in a 30 mm co-rotating intermeshing Leistritz LSM 34 GL twin-screw extruder commercially available from Leistritz AG, with a barrel temperature of 240° C. for all zones. The throughput was 25 lb/hr, and the speed was 300 RPM. All materials were molded on a 5 oz Battenfeld injection molding machine at a mold temperature of 70° C.

Test bars were conditioned for approximately 48 hours in 50% relative humidity and at 23° C. before the measurement. The results of the measurements are given in Table 1.

### EXAMPLE 3 (EX. 3)

The reactive, peroxide-containing propylene polymer made in Preparation 2 was added to a 3 liter jacketed glass reactor equipped with an agitator. The reactor was heated to and held at 135° C. for 15 min. Then, 20 pph butyl acrylate (BA), with respect to the amount of the peroxide-containing propylene polymer, was added to the reactor at a rate of 5 ml/min. Upon the completion of BA addition, 20 pph styrene, with respect to the amount of the peroxide-containing propylene polymer, was added to the reactor at a rate of 5 ml/min. The reactor temperature was then maintained at 135° C. for another 60 minutes. The reactor vent was then opened and a stream of nitrogen was introduced. The reactor was held at 135° C. for another hour to remove any un-reacted monomer and deactivate any residual free radicals and un-decomposed peroxides. The resultant graft copolymer was cooled and collected. The MFR of the resultant graft copolymer is 36 dg/min.

The graft copolymer was compounded and the test bar was prepared under the same condition as described in Example 2. The results of the measurements are given in Table 1.

### COMPARATIVE EXAMPLE 2 (COMP EX. 2)

The reactive, peroxide-containing propylene polymer made in Preparation 2 was added to a 3 liter jacketed glass reactor equipped with an agitator. The reactor was heated to and held at 135° C. for 15 min. Then, a mixture of 10 pph butyl acrylate (BA) and 10 pph styrene, with respect to the amount of the peroxide-containing propylene polymer, was added to the reactor at a rate of 5 ml/min. Upon the completion of monomer addition, the reactor temperature was maintained at 135° C. for another 60 minutes. The reactor vent was then opened and a stream of nitrogen was introduced. The reactor was held at 135° C. for another hour to remove any un-reacted monomer and deactivate any residual free radicals and un-decomposed peroxides. The resultant graft copolymer was cooled and collected. The MFR of the resultant graft copolymer is 96 dg/min.

The graft copolymer was compounded and the test bar was prepared under the same condition as described in Example 2. The results of the measurements are given in Table 1.

TABLE 1

| | | | Elon- | | | |
|---|---|---|---|---|---|---|
| | | | gation | | | |
| | | Notched | @ | Tensile | Flex | HDT @ |
| | | Izod | break | Strength | Modulus | 264 psi |
| Ex. | Polymers | (ft-lbs/in) | (%) | (psi) | (Kpsi) | (° C.) |
| Comp | Random | 0.258 | 12.4 | 4920 | 191 | 56.8 |
| Ex. 2 | PP-g- | | | | | |
| | P(S/BA) | | | | | |
| | 10/10 pph | | | | | |
| Ex. 2 | Block | 0.51 | 17 | 4910 | 205.6 | 58.5 |
| | PP-g- | | | | | |
| | (PS/PBA) | | | | | |
| | 10/10 pph | | | | | |
| Ex. 3 | Block | 0.983 | 25.4 | 4322 | 189.4 | 56.6 |
| | PP-g- | | | | | |
| | (PS/PBA) | | | | | |
| | 20/20 pph | | | | | |

The graft copolymer made by sequentially grafting polymerization process (Example 2) show a better impact properties as indicated by higher notched Izod, and elongation at break as compared with those of the graft copolymer with random polymerized graft chains (Comparative Example 2) without losing its tensile properties. The impact properties of the graft copolymer increases with the increase of the grafting monomer content.

Other features, advantages and embodiments of the invention disclosed herein will be readily apparent to those exercising ordinary skill after reading the foregoing disclosures. In this regard, while specific embodiments of the invention have been described in considerable detail, variations and modifications of these embodiments can be effected without departing from the spirit and scope of the invention as described and claimed.

What is claimed is:

1. A process for making a graft copolymer comprising:
a) treating a reactive, peroxide-containing olefin polymer material (A) at a first temperature from about 80° C. to a temperature below the softening point of the polymer material with about 5 to about 120 parts per hundred parts of the polymer material (A) by weight (pph) of at least one grafting monomer which is polymerizable by free radicals, thereby forming a stage a) graft copolymer;
b) treating the stage a) graft copolymer, after at least about 50% by weight of the monomer used in stage a) has been converted to polymer, at a second temperature from about 80° C. to a temperature below the softening point of the stage a) graft copolymer, which is the same as or different from the temperature used in stage a), with about 5 to about 120 pph of at least one grafting monomer which is different from the monomer used in stage a) and polymerizable by free radicals; and
c) simultaneously or successively in optional order,
(i) deactivating substantially all residual free radicals in the resultant graft copolymer at a temperature not lower than the second temperature; and
(ii) removing any un-reacted vinyl monomer from the grafted copolymer.

2. The process according to claim 1 wherein the reactive, peroxide-containing olefin polymer material (A) is prepared from an olefin polymer starting material selected from a propylene polymer material, an ethylene polymer material and a butene-1 polymer material.

3. The process according to claim 2 wherein the propylene polymer material is selected from:
(a) a crystalline homopolymer of propylene having an isotactic index greater than about 80%;
(b) a crystalline, random copolymer of propylene with an olefin selected from ethylene and C₄-C₁₀ α-olefins wherein the polymerized olefin content is about 1-10% by weight when ethylene is used, and about 1% to about 20% by weight when the C₄-C₁₀ α-olefin is used, the copolymer having an isotactic index greater than about 60%;
(c) a crystalline, random terpolymer of propylene and two olefins selected from ethylene and C₄-C₈ α-olefins wherein the polymerized olefin content is about 1% to about 5% by weight when ethylene is used, and about 1% to about 20% by weight when the C₄-C₁₀ α-olefins are used, the terpolymer having an isotactic index greater than about 85%;
(d) an olefin polymer composition comprising:
(i) about 10% to about 60% by weight of a crystalline propylene homopolymer having an isotactic index greater than about 80% or a crystalline copolymer of monomers selected from (a) propylene and ethylene, (b) propylene, ethylene and a C₄-C₈ α-olefin, and (c) propylene and a C₄-C₈ α-olefin, the copolymer having a polymerized propylene content of more than about 85% by weight, and an isotactic index greater than about 60%;
(ii) about 3% to about 25% by weight of a copolymer of ethylene and propylene or a C₄-C₈ α-olefin that is insoluble in xylene at ambient temperature; and
(iii) about 10% to about 85% by weight of an elastomeric copolymer of monomers selected from (a) ethylene and propylene, (b) ethylene, propylene, and a C₄-C₈ α-olefin, and (c) ethylene and a C₄-C₈ α-olefin, the copolymer optionally containing about 0.5% to about 10% by weight of a polymerized diene and containing less than about 70% by weight of polymerized ethylene, and being soluble in xylene at ambient temperature and having an intrinsic viscosity of about 1.5 to about 6.0 dl/g;
wherein the total of (ii) and (iii), based on the total olefin polymer composition is about 50% to about 90% by weight, and the weight ratio of (ii)/(iii) is less than about 0.4, and the composition is prepared by polymerization in at least two stages; and
(e) mixtures thereof.

4. The process according to claim 2 wherein the propylene polymer material is a crystalline homopolymer of propylene having an isotactic index greater than 80%.

5. The process according to claim 2 wherein the ethylene polymer material is selected from:
(a) homopolymers of ethylene;
(b) random copolymers of ethylene and an α-olefin selected from C₃-C₁₀ α-olefins having a polymerized α-olefin content of about 1% to about 20% by weight;
(c) random terpolymers of ethylene and two C₃-C₁₀ α-olefins having a polymerized α-olefin content of about 1% to about 20% by weight; and
(d) mixtures thereof.

6. The process according to claim 2 wherein the butene-1 polymer material is selected from:
(a) homopolymers of butene-1;
(b) copolymers or terpolymers of butene-1 with ethylene, propylene or C₅-C₁₀ α-olefin, the comonomer content from about 1 mole % to about 15 mole %; and
(c) mixtures thereof.

7. The process of claim 1 wherein the grafting monomer has one or more unsaturated bonds and the monomer can contain a straight or branched aliphatic chain or a substituted or unsubstituted aromatic, heterocyclic, or alicyclic ring in a mono- or polycyclic compound.

8. The process of claim 7 wherein the grafting monomer is selected from:
(a) vinyl-substituted aromatic, heterocyclic, or alicyclic compounds;
(b) unsaturated aliphatic nitriles, carboxylic acids and their esters;
(c) unsaturated acid anhydrides and salts; and
(d) halogenated vinyl compounds.

9. The process of claim 8 wherein the grafting monomer is selected from styrene, vinylnaphthalene, vinylpyridine, vinylpyrrolidone, vinylcarbazole, methylstyrenes, methylchlorostyrene, p-tert-bulylstyrene, methylvinylpyridine, ethylvinylpyridine, acrylonitrile, methacrylonitrile, and mixtures thereof.

10. The process of claim 8 wherein the grafting monomer is selected from acrylic acid esters, methacrylic acid esters, acrylic acids, methacrylic acid, unsaturated acid anhydrides, salts of unsaturated acid and mixtures thereof.

11. The process of claim 9 wherein the grafting monomer is styrene.

12. The process of claim 10 wherein the grafting monomer is methyl methacrylate.

13. The process of claim 10 wherein the grafting monomer is butyl acrylate.

14. A graft copolymer made by a process comprising:
a) treating a reactive, peroxide-containing olefin polymer material (A) at a first temperature from about 80° C. to a temperature below the softening point of the polymer material with about 5 to about 120 parts per hundred parts of the polymer material (A) by weight (pph) of at least one grafting monomer which is polymerizable by free radicals, thereby forming a stage a) graft copolymer;
b) treating the stage a) graft copolymer, after at least about 50% by weight of the monomer used in stage a) has been converted to polymer, at a second temperature from about 80° C. to a temperature below the softening point of the stage a) graft copolymer, which is the same as or different from the temperature used in stage a), with about 5 to about 120 pph of at least one grafting monomer which is different from the monomer used in stage a) and polymerizable by free radicals; and
c) simultaneously or successively in optional order,
(i) deactivating substantially all residual free radicals in the resultant graft copolymer at a temperature not lower than the second temperature; and removing any un-reacted vinyl monomer from the grafted copolymer.

15. The graft copolymer of claim 14 having a grafting efficiency not smaller than 30% wherein the grafting efficiency is 100×(C₀−C)/C₀, where C and C₀ are concentrations of the soluble polymerized monomer fraction in xylene at room temperature and the total polymerized monomer, respectively.
